(19) United States
(12) Patent Application Publication
(10) Pub. No.: US 2007/0113115 A1
(43) Pub. Date: May 17, 2007

(54) Switching circuit for clock signals

(75) Inventor: Ming-Chih Hsieh, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD

(21) Appl. No.: 11/521,922

(22) Filed: Sep. 15, 2006

(30) Foreign Application Priority Data
Nov. 11, 2005 (CN) 200510101193.0

(51) Int. Cl. G06F 1/00

(52) U.S. Cl. 713/500

(57) ABSTRACT

An exemplary switching circuit assembly for clock signals includes a chipset, a flip-flop, and a multiplexer. The multiplexer is connected between the chipset and the multiplexer. The chipset receives a reset signal and is reset by the reset signal. The flip-flop receives the reset signal and generates a control signal. The multiplexer receives the control signal and two clock signals. When the flip-flop receives the reset signal, the multiplexer alternatively outputs one of the two clock signals.

### BACKGROUND OF THE INVENTION

1. Field of the Invention

The present invention relates to switching circuits, and particularly to a switching circuit for clock signals.

2. Description of Related Art

In general, in a computer system, some chipsets often use different frequency clock signals to perform different functions, thus requiring switching between different clock signals and resetting of the chipsets.

Referring to FIG. 3, a conventional switching circuit 12′ is shown. The switching circuit 12′ is electrically connected to a chipset 20′, the switching circuit 12′ includes a first clock input CLK1′ receiving a first clock signal, a second clock input CLK2′ receiving a second clock signal, a select terminal SEL′, and an output terminal CLKOUT′. The chipset 20′ includes a reset terminal RST′ for receiving a reset signal. The clock switching circuit 12′ of FIG. 3 switches between the first clock signal and the second clock signal based on a select signal at the select terminal SEL′ and outputs one signal as an output clock signal to the chipset 20′. When the chipset 20′ requires a change in clock signal, a reset signal is applied to the reset terminal RST′ to reset the chipset 20′. Then the select signal is applied to the select terminal SEL′ of the switching circuit 12′ to switch the clock signal output to the chipset 20′.

However, the reset signal and the select signal are two different signals, if the reset signal and the select signal are not synchronized with each other, circuit malfunction may occur in the computer system.

What is needed is to provide a switching circuit for clock signals which overcomes the above problem.

### SUMMARY OF THE INVENTION

An exemplary switching circuit assembly for clock signals includes a chipset, a flip-flop, and a multiplexer. The multiplexer is connected between the chipset and the multiplexer. The chipset receives and is reset by a reset signal. The flip-flop receives the reset signal and generates a control signal. The multiplexer receives the control signal and two clock signals. When the flip-flop receives the reset signal, the multiplexer alternatively outputs one of the two clock signals.

Other advantages and novel features of the invention will become more apparent from the following detailed description when taken in conjunction with the accompanying drawings, in which:

### BRIEF DESCRIPTION OF THE DRAWINGS

FIG. 1 is a block diagram of a switching circuit for clock signals in accordance with a preferred embodiment of the present invention, together with a chipset;

FIG. 2 is a circuit diagram of the switching circuit of FIG. 1; and

FIG. 3 is block diagram of a conventional switching circuit.

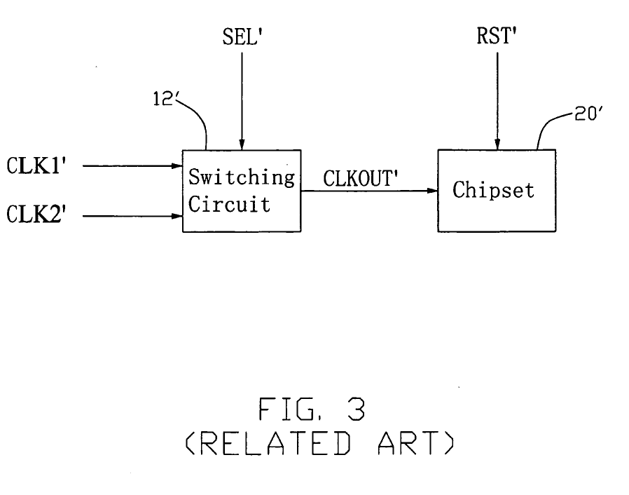

### DETAILED DESCRIPTION OF THE INVENTION

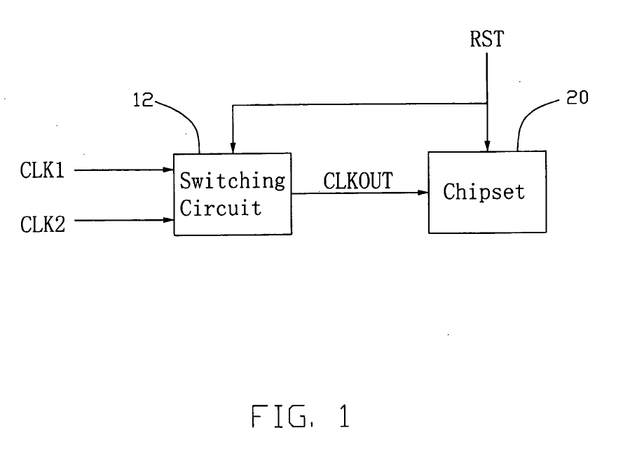

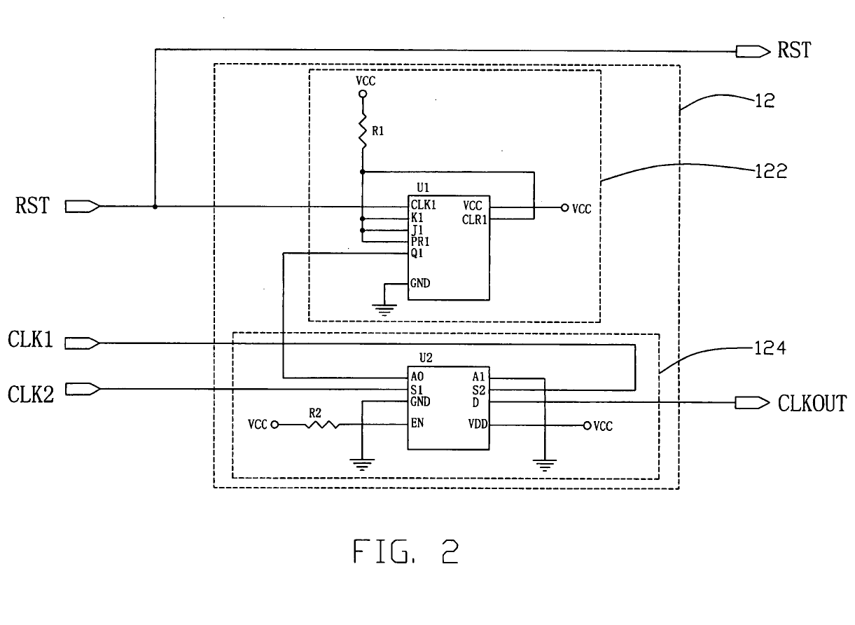

Referring to FIGS. 1 and 2, a switching circuit 12 for clock signals in accordance with a preferred embodiment of the present invention is shown. The switching circuit 12 includes a first clock input CLK1, a second clock input CLK2, an output CLKOUT, and a reset input RST. The first clock input CLK1 receives a first clock signal, and the second clock input CLK2 receives a second clock signal. The output CLKOUT is connected to a chipset 20 for selectively providing the first clock signal or the second clock signal to the chipset 20. The chipset 20 has a reset terminal connected to the reset input RST of the switching circuit 12. When a reset signal is provided to the reset terminal of the chipset 20, the chipset 20 is reset.

The switching circuit 12 includes a detector 122 and a selection unit 124. The detector 122 includes a power supply VCC, a first resistor R1, and a flip-flop U1. The selection unit 124 includes a power supply VCC, a second resistor R2, and a multiplexer U2. The flip-flop U1 is a 74LVX112 chipset, and the multiplexer U2 is an ADG704 chipset.

A CLK1 pin of the flip-flop U1 acts as the reset input RST. K1, J1, PR1, and CLR1 pins of the flip-flop U1 are connected to the power supply VCC via the first resistor R1. A VCC pin of the flip-flop U1 is connected to the power supply VCC, and a GND pin of the flip-flop U1 is grounded. A Q1 pin of the flip-flop U1 is connected to an A0 pin of the multiplexer U2. An S1 pin of the multiplexer U2 acts as the second clock input CLK2, an S2 pin of the multiplexer U2 acts as the first clock input CLK1, an A1 pin of the multiplexer U2 is grounded, an EN pin of the multiplexer U2 is connected to the power supply VCC via the second resistor R2, and a D pin of the multiplexer U2 acts as the output CLKOUT, and is connected to the CHIPSET 20. A VDD pin of the multiplexer U2 is connected to the power supply VCC, and a GND pin of the multiplexer U2 is grounded. Truth tables of the flip-flop U1 and the multiplexer U2 are as follows:

Truth table of flip-flop U1

| | |
|---|---|
| Inputs | Outputs |

| PR | CLR | CLK1 | J | K | Q1 | Q1 |
|---|---|---|---|---|---|---|
| L | H | X | X | X | H | L |
| H | L | X | X | X | L | H |
| L | L | X | X | X | H | H |
| H | H | [symbol] | H | H | Q̅₀̅ | Q₀ |
| H | H | [symbol] | L | H | L | H |
| H | H | [symbol] | H | L | H | L |
| H | H | [symbol] | L | L | Q₀ | Q̅₀̅ |

Note:
H = High Level
L = Low Level
X = Irrelevant [symbol]
= High to Low transition
Q₀ = Level of Q1 before any change at the outputs

Truth table of multiplexer U2

| A1 | A0 | EN | ON Switch(D) |
|---|---|---|---|
| X | X | 0 | NONE |
| 0 | 0 | 1 | S1 |
| 0 | 1 | 1 | S2 |
| 1 | 0 | 1 | S3 |
| 1 | 1 | 1 | S4 |

Note:
1 = High Level
0 = Low Level
X = Irrelevant

In operation, to switch from one clock signal to another of the chipset 20, a high to low transition reset signal is applied to the reset terminal of the chipset 20 to reset the chipset 20. At the same time, the same reset signal is applied to the CLK1 pin of the flip-flop U1, levels of the K1, J1, PR1, and CLR1 pins remain at high levels, and a voltage at the Q1 pin changes state when the CLK1 signal falls from a logic high to logic low according to the truth table of the flip-flop U1. The signal at the Q1 pin is transmitted to the A0 pin of the multiplexer U2, a signal at the A1 pin is at a low level, and a signal at the EN pin is at a high level. If the signal at the Q1 pin is at a low level, according to the truth table of the multiplexer U2, an output at the D pin of the multiplexer U2 is same with the signal at the S1 pin, that is, the second clock signal CLK2 is output to the chipset 20. If the signal at the Q1 pin is at a high level, according to the truth table of the multiplexer U2, an output at the D pin of the multiplexer U2 is same with the signal at the S2 pin, that is, the first clock signal is output to the chipset 20. A change of state in the signal at the A0 pin of the multiplexer U2 causes the multiplexer 20 to switch between the two clock signals.

In this preferred embodiment, the chipset 20 receives the reset signal and is reset by the reset signal, the flip-flop U1 receives the reset signal at the same time, the flip-flop U1 changes the state of the output signal and transmits the output signal to the multiplexer U2, and the multiplexer U2 changes the clock signal to the chipset 20 from one clock signal which is provided to the chipset 20 before the reset signal is generated to the other. In this embodiment, using one reset signal to control a clock signal switching and a chipset reset prevents malfunction at the time of clock switching.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A switching circuit assembly comprising:
a chipset receiving a reset signal and being reset by the reset signal;
a flip-flop for receiving the reset signal and generating a control signal according to the reset signal; and
a multiplexer connected between the chipset and the flip-flop, the multiplexer receiving the control signal and two clock signals, wherein when the flip-flop receives the reset signal, the multiplexer alternatively outputs one of the two clock signals.

2. The switching circuit as claimed in claim 1, wherein the flip-flop is a 74LVX112 chipset and has an input receiving the reset signal, and an output outputting the control signal, when the flip-flop receives the reset signal, the output outputs the control signal to the multiplexer.

3. The switching circuit as claimed in claim 2, wherein the multiplexer is an ADG704 chipset and has a first input receiving a first clock signal, a second input receiving a second clock signal, a third input connected to the output of the flip-flop for receiving the control signal from the flip-flop, and a ground terminal connected to ground.

4. A switching circuit assembly for clock signals comprising:
a flip-flop having an input for receiving a reset signal, an output outputting a control signal, the flip-flop changing a state of the control signal on a falling edge of the reset signal;
a multiplexer having a first input coupled to a first clock signal, a second input coupled to a second clock signal, a control input receiving the control signal, and an output alternately outputting one of the first clock signal and the second clock signal according to the control signal; and
a chipset having an input coupled to the output of the multiplexer, and an reset terminal receiving the reset signal.

5. The switching circuit as claimed in claim 4, wherein the flip-flop is a 74LVX112 chipset.

6. The switching circuit as claimed in claim 5, wherein the multiplexer is an ADG704 chipset.

7. A switching circuit for resetting a chipset, comprising:
a detector having an input for receiving a reset signal, an output outputting a control signal; and
a selection unit having a first input for coupling to a first clock signal, a second input for coupling to a second clock signal, a control input receiving the control signal, and an output for coupling to the chipset, wherein
a state of the control signal is changable in response to the reset signal to thereby allow the selection unit alternately outputting one of the first clock signal and the second clock signal to the chipset.

8. The switching circuit as claimed in claim 7, wherein the detector is a flip-flop.

9. The switching circuit as claimed in claim 7, wherein the selection unit is a multiplexer.

10. The switching circuit as claimed in claim 7, wherein the state of the control signal is changable on a falling edge of the reset signal.
